(19) United States
(12) Patent Application Publication
(10) Pub. No.: US 2015/0136845 A1
(43) Pub. Date: May 21, 2015

(54) PROCESS AND SYSTEM FOR THE IDENTIFICATION AND TRACKING OF PRODUCTS IN A PRODUCTION LINE

(71) Applicant: Valid Solucoes e Servicos De Seguranca EM Meios De Pagamento e Identificacao S.A., Rio de Janeiro (BR)

(72) Inventor: Fernanda de Araujo Silva, Rio de Janeiro (BR)

(21) Appl. No.: 14/541,448

(22) Filed: Nov. 14, 2014

(30) Foreign Application Priority Data
Nov. 18, 2013 (BR) 102013029648-1

(51) Int. Cl. G06Q 30/00; G06K 1/12

(52) U.S. Cl. CPC G06Q 30/0185; G06K 1/121
USPC 235/375

(57) ABSTRACT

The present invention is related to processes used to combat counterfeiting. To that end, there is provided an efficient process and system for the identification and tracking of products in a production line, thereby allowing the marketed products to be further tracked in an efficient and unambiguous manner. More particularly, the present invention provides a process for the identification and tracking of products in a production line, comprising the steps: (a) recognizing each of the products, (b) digitally generating at least one identification code for each of the products, (c) printing, for each of the products, the at least one code directly on the corresponding product, and (d) validating each of the codes printed on the products. The present invention further provides a system capable of carrying out the above process.

### TECHNICAL FIELD

The present invention is related to processes used to reduce product counterfeiting. More particularly, the present invention is related to processes that provide for better control and tracking of products so as to make any type of counterfeiting difficult.

### DESCRIPTION OF THE STATE OF THE ART

Due to the strong appeal to consumption, there was a remarkable increase in the concern with product counterfeiting and tax evasion, both in the public and private sectors.

At every moment, we are faced with governmental actions for combating piracy, either through institutional advertisements or police repression with the apprehension of counterfeit products. Despite this effort to reduce this illegal and unfair practice as the country does not collect taxes due to product counterfeiting and tax evasion, all these measures are insufficient to prevent the problem from happening.

Product counterfeiting and tax evasion cause damage to the society, considered individually, and to the State. This is because it prejudices the integrity and credibility of companies owning certain brands or patents, which have extensive damage by loosing market for pirated products; causes losses of copyrights; provides products of low quality that are not in agreement with the established technical standards, which can cause damage to consumers' health and safety; generates losses of state revenue; causes emptying of jobs because unfair competition from counterfeit products leads to the inevitable loss of companies' revenues; finally, there is an increase in violence, since it has been proven that profits from the sales of counterfeit products fund organized crime.

The consumer who buys a counterfeit product will not be covered by the protective system of Law 8078/90 in case of a flaw or defect in the product. Obviously there is a legal assumption that the product put into circulation was introduced in the consumption chain by the vendor. However, this assumption is not absolute and can be excluded if proven otherwise.

Therefore, if the product's supplier, as a manufacturer, builder, producer or importer, demonstrates that the flaw or defective product was not introduced in the market by him, he may not be held responsible for any damages that may result from the product.

There are no advantages in buying a counterfeit product. In contrast, there are several serious consequences to the consumer, from the individual, society and State's point of view.

Today, products are manufactured in large scale using several raw-products, packages, customized and authenticable characteristics, from a specific Market Share, among other aspects.

The issue of authenticity is particularly relevant since there is a need for some products of high added value, for example, or in highly competitive markets, to be distinguished by their intrinsic characteristics from copies or products sharing the same market segment.

Despite the added value or special characteristics, the importance of ensuring quality and quantity of the manufactured products is undeniable. Not only due to the economic aspect, but also due to the possible aspect of uniqueness or the need for differentiation either by the consumer or any other entities having specificities in their field of action, either public or private entities.

The State of the Art relies on a variety of resources to control the manufacture of products, from the control, origin and specificity of raw materials, such as security imprints, for example, counting of manufactured products and the verification of what was used to generate the products. Therefore, one can obtain, with reasonable accuracy, how much was involved to generate a certain amount of products.

This technique is not sufficiently accurate to ensure the produced quantity nor other variables involved in the manufacture process.

The current technique still relies on resources to ensure the authenticity of products, particularly by checking some special characteristics on the packages, which can be done by various “techniques” such as, those sensitive to ultraviolet or infrared radiation, graphic elements printed with touch-sensitive inks such as chalcographic inks, among others.

The present invention proposes a way to remediate the drawbacks of the prior art by allowing one ensure authenticity of products as well as the amounts produced using a novel technique applied in the manufacture environment.

### OBJECTS OF THE INVENTION

The object of the present invention is to provide an efficient process and system for the identification and tracking of products in a production line, thereby allowing the marketed products to be further tracked in an efficient and unambiguous manner.

### BRIEF DESCRIPTION OF THE INVENTION

In order to achieve the aforementioned objects, the present invention provides a process for the identification and tracking of products in a production line, comprising the steps of: (a) recognizing each of the products, (b) digitally generating at least one identification code for each of the products, (c) printing, for each of the products, the at least one code directly on the corresponding product, and (d) validating each of the codes printed on the products.

The present invention further provides a system capable of carrying out the above process.

### DESCRIPTION OF THE FIGURES

The following detailed description makes reference to the accompanying drawings, in which:

FIG. 1 illustrates a block diagram of the process in accordance with the preferable embodiment of the present invention;

FIG. 2 illustrates a flow chart of the steps of the process of the present invention.

### DETAILED DESCRIPTION OF THE INVENTION

The following description will be based on a preferred embodiment of the invention. As will be evident to the skilled person, however, the invention is not restricted to this particular embodiment.

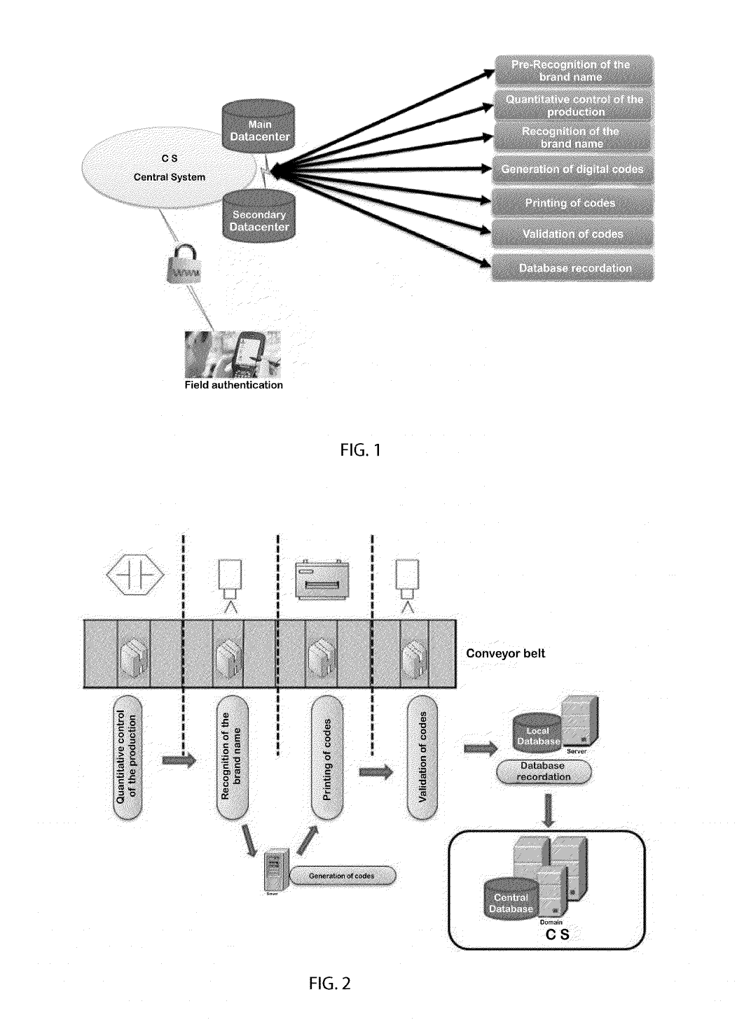

FIGS. 1 and 2 illustrate in general the process for the identification and tracking of products in a production line. The following solution was designed so as to provide quantitative control of the production, recognition of the brand name, generation of digital codes, printing of the codes, validation of the codes and recordation in a data base.

The present invention contemplates a Central System—SC, that enables follow up of the production cycle through software tools, in addition to mobile devices capable of reading and authenticating the code printed on the product, which will be further detailed below.

In particular, the SC consists of a management and centralizing station that enables the follow up of the entire production cycle. It can be, for example, a processor connected to all the tools used in the process and system in accordance with the present invention.

The first step of the process in accordance with the present invention is related to recognition of each of the products in the production line. This step recognizes the brand name based on the recognition of characteristics of the product package in a production line. Automated recognition of the brand name of the product is made by comparing images of the product with a template previously stored in the informational system and/or by reading the commercial barcode.

In one embodiment of the present invention, the above referenced comparison of product images can be made by pre-storing templates of package images of the products in the production line. Each of the templates can be stored by mapping subdivisions of the image and/or of each of its pixels, e.g., by quantizing the intensity of color of each one of the subdivisions and the position occupied by the subdivision in said image. Thus, the same procedure can be applied to images detected on packages of products in the production line and a comparison of the mapped parameters can be made between the detected image and the stored templates. If the comparison of the detected image and one of the templates results in a similarity higher than a certain threshold value, the product package is then identified and associated with a certain corresponding product.

The second step of the process in accordance with the present invention is related to digitally generating at least one identification code for each of the products in the production line. This step comprises the systemic and secure generation of digital codes by using cryptographic techniques to ensure uniqueness of the product in a production line by automatically generating codes to be printed on the body or on any other media to be applied to the object.

The code format can be either numeric or alphanumeric and can be incremented in any order, on any structure predefined by the client of the solution. One can operate with several typologies and in addition to numeric or alphanumeric codes, they can be both linear and 2D bar codes, such as Datamatrix, QRcode or pdf 417.

In the creation of a single code having mechanisms to ensure its origin, a generating software tool is used having one or more seeds. Seed is any and all information, either fixed or variable, used to feed a cryptographic motor thereby resulting in new seeds or high entropy keys.

Preferably, cryptographic seeds are generated based on shared secret algorithms (Shamir's Secret Sharing system, for example) in order to prevent unilateral actions from the seed detainers.

Symmetric and/or asymmetric cryptographic keys having type and size consistent with the marketing best practices and guidelines from the National Institute of Information Technology (ITI) can be used.

Preferably, all the communication through the system that is made with the code generator is established via the Transport Layer Security (TLS) protocol with mutual authentication and using the digital certificate for the intended purpose issued by a certifying authority homologated by the Brazilian Public Key Infrastructure (ICP-Brazil).

The third step of the process in accordance with the present invention is related to printing the codes digitally-generated in the previous step. Preferably, printing is made directly on the product package via a single e unique process that ensures authenticity (origin) of the code printed on the product. Optionally, labeling can also be made based on digital codes on a substrate that will be thereafter applied/glued on the product package.

Preferably, printing of the object in the production line is made using high speed industrial ink-jet printers with visible or invisible, indelible ink. This ink has forensic characteristics that ensure authenticity of the code origin.

In an additional process step in accordance with the present invention, quantitative control of the production is made. To that end, the present invention individually counts objects passing through a production line by means of presence and/or proximity sensors placed strategically and redundantly in the production line, allowing for counting of the products, regardless of their transparency, color, shape or texture conditions. This step is preferably made prior to the step of recognizing the product brand/package in the production line. Alternatively, this step is only made after the codes are printed on the products.

For example, product counting can be made through at least one sensor that identifies spaces between products and/or at least one sensor capable of identifying the size of products along the final extension of a production conveyor belt. Product size, more specifically, the length thereof, can be determined by calibrating the speed of the conveyor belt. For example, one can perform an initial counting based on the amount of spaces between each one of the products. In the case of products that are too close to each other, where there is no spacing between them, the size of the object can be identified. If the size of the object identified by the sensor is two or three times greater than the standard size of a product in the production line, one can conclude that two or three objects are present in relatively close proximity to each other. Therefore, this correction factor is added to the initial count based on the spacing present between the products.

The process in accordance with the present invention further provides a step of validation of codes printed on the products. This step comprises reading and authenticating the code printed on the product in order to validate it. In this step, printing quality of the codes can be verified and the code assigned to the object can be validated and recorded.

The present invention further provides a step of recordation of information obtained in all the previous steps, such as product identification, counting thereof, and codes associated with each one of them, in a database also controlled by the SC. This information can be stored in one or more datacenters in communication with the SC, as illustrated in FIGS. 1 and 2.

Therefore, the present invention provides an efficient process for the identification and tracking of products in a production line, thereby allowing the marketed products to be further tracked in an efficient and unambiguous manner. For example, a handheld equipment can be used to validate the code in an exclusive and unique manner.

Code verification is a process consisting of demonstrating the shape and origin of the same. This process can be made by recognizing unique and exclusive features included in the ink used to print the code and/or by cryptographic operations which, based on generation seeds, demonstrate that the code is authentic. The verifying machine can be capable of, for example, recovering cryptographic seeds used when generating the codes and validating authenticity and integrity of a code.

As already mentioned, the present invention further provides a system capable of carrying out the above process. Said system comprises, in addition to the SC, all the mentioned equipment responsible for carrying out the aforementioned steps.

Several variations under the scope of protection of the present application are possible. Therefore, the present invention is not limited to the aforementioned particular configurations/embodiments.

1. A process for the identification and tracking of products in a production line, characterized in that it comprises the steps of:
a) recognizing each of the products;
b) digitally generating at least one identification code for each of the products;
c) printing, for each of the products, the at least one code directly on the corresponding product;
d) validating each of the codes printed on the products; and

2. The process of claim 1, characterized in that it further comprises the step of counting the products in the production line.

3. The process of claim 1, characterized in that it further comprises the step of recording information obtained in steps (a) to (e) in a database.

4. A system for the identification and tracking of products in a production line, characterized in that it comprises:
means for recognizing each one of the products;
means for digitally generating at least one identification code for each of the products;
means for printing, for each of the products, the at least one code directly on the corresponding product;
means for validating each of the codes printed on the products.

5. The system of claim 4, characterized in that it further comprises means for counting the products in the production line.
